(19) United States
(12) Patent Application Publication
(10) Pub. No.: US 2007/0267517 A1
(43) Pub. Date: Nov. 22, 2007

(54) Telescopic Liquid-Ejection Device for Vehicle Window-Washing Systems

(76) Inventors: Miquel Mota Lopez, Rubi (ES); Juan Jesus Elvira Peralta, Rubi (ES)

Correspondence Address: RATNERPRESTIA, P O BOX 980, VALLEY FORGE, PA, 19482-0980, US

(21) Appl. No.: 10/580,639

(22) PCT Filed: Nov. 23, 2004
(86) PCT No.: PCT/EP04/13255

§ 371 Date: Mar. 14, 2007

(30) Foreign Application Priority Data
Nov. 25, 2003 (ES) U 200302713

(51) Int. Cl. B60S 1/46

(52) U.S. Cl. 239/284.1

(57) ABSTRACT

A telescopic liquid-ejection device for vehicle window-washing systems is provided. It comprises a hollow outer section and a hollow inner rod connected at one end to a nozzle and sliding inside said hollow outer section against the force of a spring under pressure exerted by said liquid. Selective means for communication which enables the liquid to move to the nozzle, when said hollow inner rod has reached a predetermined extended position. One far end of the nozzle has a flattened configuration and the nozzle and part of the hollow inner rod can protrude from an outer surface of the vehicle when the hollow inner rod is in an extended position, whereas when it is in a retracted position, said flattened configuration lies flush of under this surface.

### FIELD OF THE INVENTION

The present invention concerns a telescopic liquid-ejection device for vehicle window-washing systems, which has at least one assembly configuration for fixing the device to the structure of a vehicle and a nozzle with a flattened configuration for lying flush against the outer surface of said vehicle.

### BACKGROUND OF THE INVENTION

Numerous liquid-ejection devices for cleaning vehicle windows are known, the majority of them comprising a series of sections, generally a jet section, which is connected to a tank of liquid via a conduit, and an ejection or nozzle section, joined in a non-extendible way, although it is possible to turn the nozzle with respect to the jet section. Said devices are both fixed to the vehicle via certain means positioned on the jet section or on the vehicle, such as flaps, clamps, fixing devices, etc., and the ejection or nozzle sections have different configurations, depending on the type of liquid outlet required, whether in the form of a fan or fixed jet, or have the possibility of regulating the direction of said liquid, etc., for which said nozzles have different shapes and forms inside for adjusting to the desired requirements.

Patent WO-02/060589, which designates Spain and belongs to the present applicant, proposes a device for projecting cleaning liquid for window washer jets on cars, which comprises a jet section and a fan-shaped cleaning-liquid projection unit which are both coupled in the way described above. Said projection unit is comprised of two projection sections coupled together, and said device has certain coupling means in its jet section which, in an example of embodiment shown in FIG. 7 of the document in question, are in the shape of a flap which ends in a small tab.

Patent application DE-10220579.5 sets out a system for cleaning headlights and/or windows of motor vehicles, and a series of nozzle configurations for use by said system. One of said configurations consists in a telescopic nozzle with at last one hollow cylinder for applying the cleaning liquid to the surface to be cleaned. Although the working of said system is given in good detail, including pumps, tanks, pipes used, etc., at no time does it mention how the device, of which said nozzle forms a part, is attached to said vehicle.

An important problem of many of the existing window-washer devices used on vehicles currently on the market is that many of them cannot be used on certain areas of vehicle windows, which means that these areas are not sprayed, whether this is because the devices are not sufficiently orientable or because there are other external parts or accessories of the vehicle which are physically positioned in the path of the liquid ejected by the devices, such as the arms of windshield wipers. This problem is increased if the windows are shaped so that it makes them difficuft to spray, such as when they are vertical, in which case it is very important that the ejection devices are properly pointing at them, especially if we consider the effect the wind might have on deviating the jet of liquid exiting therefrom. To solve these problems, not only must a telescopic device be used, similar to the one proposed in patent application DE-10220579.5 mentioned above, but it must also be configured in such a way that it allows wide adaptability when mounted on different parts of different vehicles of varying shapes and sizes, depending on each particular case.

In the state of the art, neither do other devices appear of such a class which, by their configuration, can adapt to different external parts of different vehicles so that; in a single type of device, they can cover different types of windows, whether rear or front, with different gradients of slope (including completely vertical), shape and size, as well as adapting to different outer structures of vehicles and different ways for avoiding possible obstacles, such as the arms of windscreen wipers.

It is therefore useful to offer an alternative to the state of the art which, for a device similar to the one proposed in the German patent application mentioned, is configured in a way suitable for assembly on the outer surface of the structure of a vehicle, such as the bonnet, as well as the possibility that the nozzle of said device lies flush, and therefore hidden, against the outer surface of said vehicle.

### BRIEF DESCRIPTION OF THE INVENTION

The present invention proposes a telescopic liquidejection device for vehicle window-washing systems which comprises a hollow outer section connected at one end, via conduits, to a supply source of said liquid under pressure, such as a pump connected to a tank, and a hollow inner rod connected at one end to a nozzle and mounted in such a way that it can slide inside said hollow outer section against the force of a spring under pressure exerted by said liquid. There are selective means for communication on said device to enable the liquid to move to said nozzle only when, or as from when, said hollow inner rod has reached a predetermined extended position, sufficient liquid being channelled to the vehicle window by turning the nozzle, which can have any form of configuration depending on whether the liquid is to be projected in a fan-shape or as a jet. The outer hollow section has at least one assembly configuration, which comprises a lug joined laterally thereto, for fixing the device to the structure of a vehicle, and for which the far end of the nozzle has a flattened configuration which can lie flush with, or further inside than, the outer surface of said vehicle, close to the window, when the hollow inner rod is in a retracted position, the device being completely hidden when not in use, in a similar way to an automatic sprinkler when not watering the lawn.

The type of assembly configuration of the device and its construction are such that they enable it to be fixed to different outer structures of different vehicles, without the need to change the design of the device in any way at all, such as the bonnet of a vehicle, if the front windscreen is to be sprayed, or any other part in any way, close to the rear window, if this is to be sprayed, whatever the slope of said windows and the obstacles that the jet of liquid ejected by the device might encounter on said structures, which will be resolved either by extending it over said obstacles, or by selecting the most suitable position for assembly in order to avoid them. It is worth highlighting the fact that all this is achieved in such a way that the device in no way visually alters the aesthetic shape of the vehicle, due to its flattened configuration, as mentioned above, and the fact that it is retractable, it remains completely concealed in the outer structure wherein it is installed, when not in use.

### BRIEF DESCRIPTION OF THE DRAWINGS

Other characteristics of the invention will be seen more clearly from the description which follows of an example of embodiment shown in the attached drawings and which must be taken as an illustrative and non-limitative example.

An example of embodiment is explained below, referring to the attached drawings, wherein:

FIG. 1 shows a partially-sectioned perspective view of the device being the object of the present invention, in a retracted position;

FIG. 2 shows the same example of embodiment as FIG. 1 but with the device in an extended position;

FIG. 3 shows the device in FIG. 1, in an extended position, mounted on the outer, front structure of a vehicle, as a preferred example of embodiment;

FIG. 4 shows the device mounted, as seen in FIG. 3, but in a retracted position;

FIG. 5 sets out another example of embodiment wherein the device in FIG. 1 is mounted on the outer, rear structure of a vehicle, in an extended position;

FIG. 6 reproduces the example of embodiment in FIG. 5, but with the device in a retracted position;

FIG. 7 shows the device in FIG. 5 and part of the vehicle on which it is installed;

FIG. 8 shows another example of embodiment wherein the device is also used for spraying the rear window of a vehicle, which is substantially vertical, as another example of embodiment;

in FIG. 9 the device being the object of the present invention is mounted on the bonnet of an car as another example of embodiment;

FIG. 10 shows the device in FIG. 1 mounted on the outer, front structure of a vehicle as another example of embodiment; and

FIG. 11 shows the same example of embodiment as FIG. 10, but in a retracted position.

### DETAILED DESCRIPTION OF AN EXAMPLE OF EMBODIMENT

As shown in the figures, the telescopic liquid-injection device for vehicle window-washing systems proposed by the present invention comprises a hollow outer section 1 connected at one end to a supply source of said liquid under pressure and a hollow inner rod 2 connected at one end to a nozzle 3 and mounted in such a way that it can slide inside said hollow outer section 1 against the force of a spring 5 under pressure exerted by said liquid, there being selective means for communication to enable the liquid to move to said nozzle 3 only when, or as from when, said hollow inner rod 2 has reached a predetermined extended position.

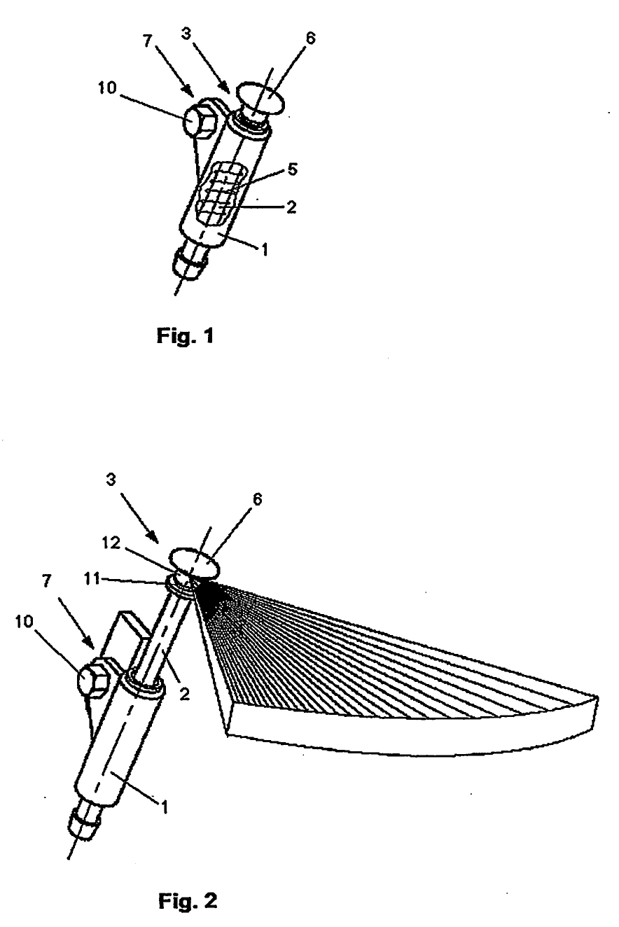

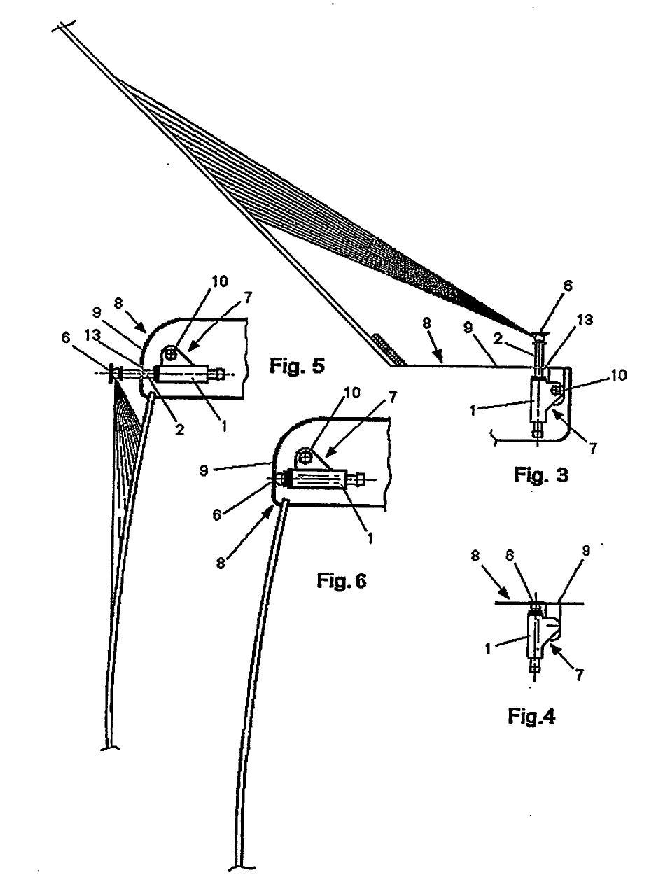

One far end of the nozzle 3 has a flattened configuration 6 and the outer hollow section 1 has at least one assembly configuration 7 for fixing the device to the structure 8 of a vehicle. Said assembly configuration 7 comprises a lug which is joined laterally to the hollow outer section 1 (see FIGS. 1, 2, 3 and 4), oriented in the longitudinal direction of the hollow outer section 1 and with an orifice for inserting a fixing element 10, such as a screw, in a cross direction with respect to the outer hollow section 1, as can be seen in FIGS. 3, 4 and 5.

In FIGS. 1 and 2, it can be seen how the nozzle 3 has housing 11 for a turntable element 12 which includes an outlet for the liquid in a side position and a passage which communicates the inside of the hollow inner rod 2 with said liquid outlet in different positions of said tumableelement, said flattened configuration 6 being joined on the outside to said housing 11. Thanks to said tumable element 12, the jet or fan outlet (see FIG. 2) can be pointed towards the desired area of the vehicle window.

In the same Figures, it can also be seen how the flattened configuration 6 extends to a perimeter which is larger than that of the housing 11.

In FIG. 4, when the device is mounted on the outer structure of a vehicle, in this case at the front, i.e. the bonnet, it can be seen how, when the device is not in use, i.e. when the hollow inner rod 2 is in a retracted position, due to the flattened configuration 6 on the far end of the nozzle 3 which lies flush with, or further inside than, the outer surface 9 of such vehicle, close to the window, the device is practically hidden from view, fitting into an opening 13 with a perimeter wherein said perimeter of the flattened configuration 6 can be substantially adjusted, both perimeters being circular, as a preferred example of embodiment. The same situation is reflected in FIGS. 6 and 11 as other examples of embodiment, the device in FIG. 6 being mounted horizontally on the rear structure 8 of a vehicle, and in FIG. 11, on the front structure 8, but in a different way from that in FIG. 4.

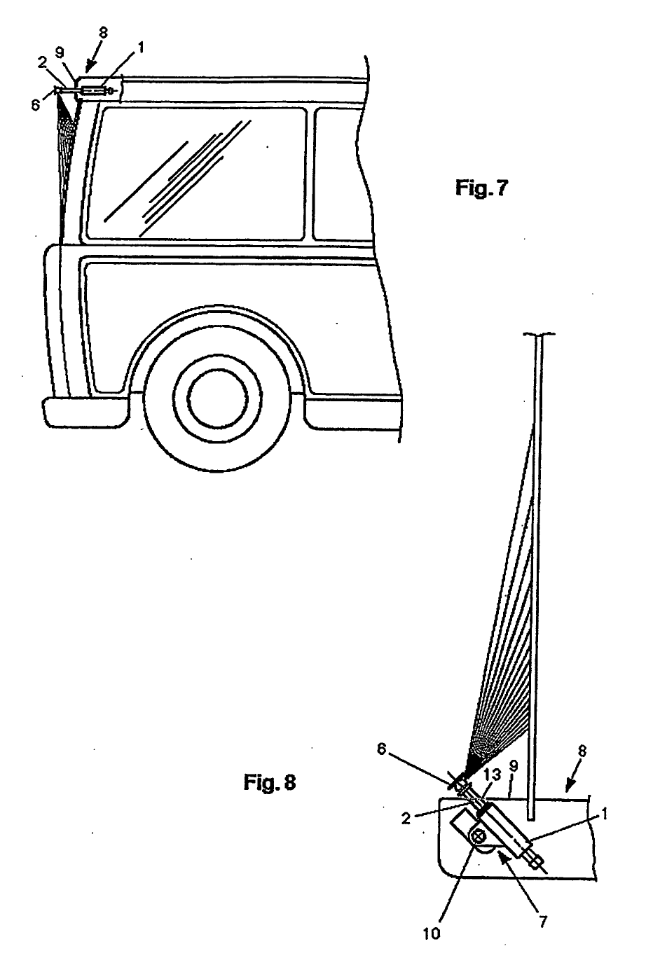

In FIGS. 3 and 5, the device being the object of the present invention can be seen in full working order, i.e. in an extended position, in FIG. 3 it being mounted, as in FIG. 4, on the front structure 8 of a vehicle close to the front window or windscreen, and in FIG. 5, as in FIG. 6, on the rear structure 8 of a vehicle, thus showing two representative examples of embodiment of the device assembly. In said Figures, it can also be seen, in the situation shown, how the nozzle 3 and part of the hollow inner rod 2 protrude from said outer surface 9 of the structure 8, when the hollow inner rod 2 is in an extended position, and how the nozzle 3 and part of the hollow inner rod 2 protrude from the aforementioned opening 13.

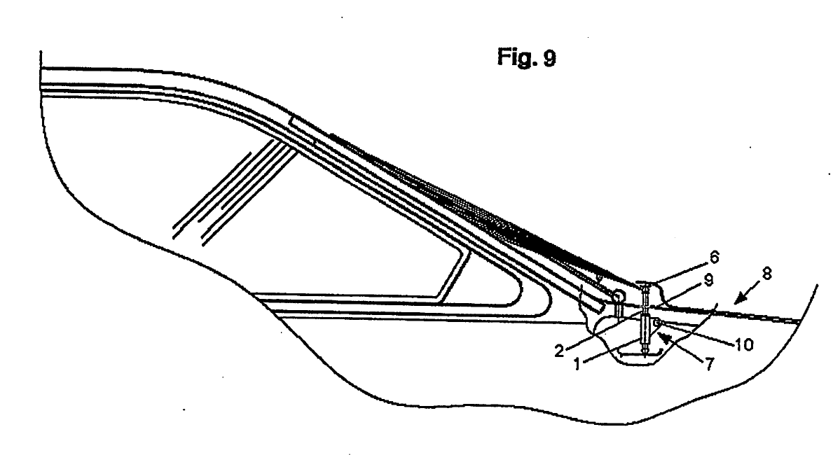

The example of embodiment reflected in FIG. 5 can be seen in greater perspective in FIG. 7, where part of the vehicle incorporating the device can be seen. Here, the rear window of the vehicle which is sprayed by the liquid ejected from the device is almost vertical, which for a traditional fastened-down jet would pose a real problem, but which is solved by the fact that the device proposed by the present invention is telescopic and can move to the most suitable position due to the particular configuration of its assembly.

An example of a position different from that proposed in FIG. 7 but used to achieve the same result, i.e. spraying a rear window of an car, which is substantially vertical, is that shown in FIG. 8, wherein the device is not only mounted below the vehicle window, unlike that in FIG. 7, but which is in an sloped position to better respond to the objective of the liquid coming out of it reaching practically the whole window. Obviously, a combination of the two examples of embodiment just mentioned is possible, i.e. using two devices positioned in different areas around the window to be sprayed, working together to clean the window more entirely.

In FIG. 9, another example of embodiment can be seen, wherein part of the vehicle on which the device is installed can also be seen (as in FIG. 7). In this case, the device is mounted on the car bonnet, in a similar way to that shown in FIG. 3, but with the difference that here the device is also partially hidden when it is in the extended position, i.e. when in full working order, due to a visor which, in this case, forms part of the bonnet, but which could be a separate part which is mounted thereon. Said visor not only partially hides the device but also protects it from external aggression, while maintaining aesthetic uniformity whether the device is working or not.

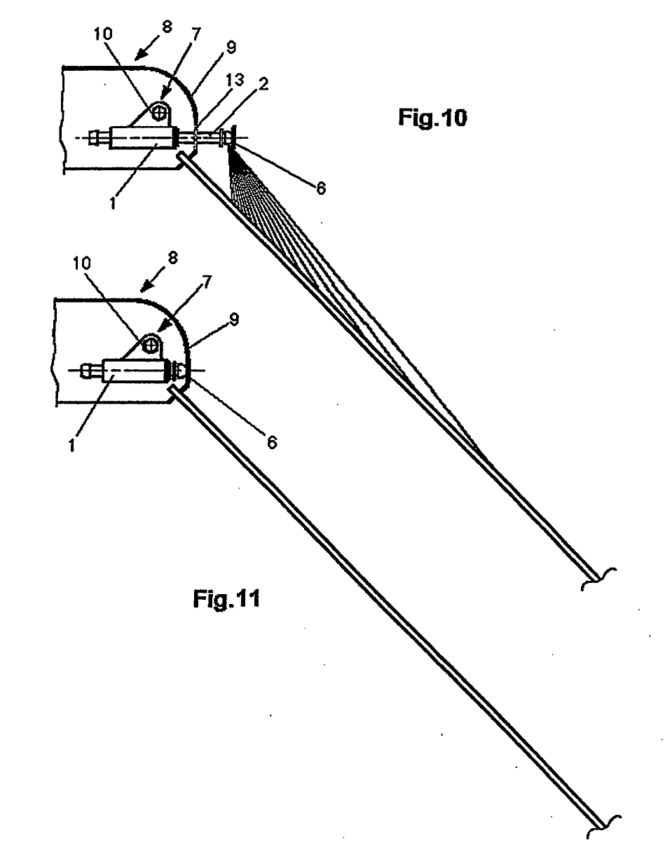

Lastly, FIGS. 10 and 11 show another example of embodiment wherein the device (in an extended position in FIG. 10) being the object of the present invention is mounted on the front, outer structure 8 of a vehicle, more specifically on the area above the window of the vehicle, thus spraying downwards, avoiding, for example, the arms of the window wipers.

A person skilled in the art could introduce changes and modifications to the example of embodiment described without going beyond the scope of the invention, as defined in the attached claims.

1. Telescopic liquid-ejection device for vehicle window-washing systems, of the type which comprises a hollow outer section connected at one end to a supply source of said liquid under pressure and a hollow inner rod connected at one end to a nozzle and mounted in such a way that it can slide inside said hollow outer section against the force of a spring sunder pressure exerted by said liquid, it having selective means for communication which enable enables the liquid to move to the nozzles, only when, or as from when, said hollow inner rod has reached a predetermined extended position, wherein a far end of the nozzle has a flattened configuration and the hollow outer section has at least one assembly configuration for fixing the device to the structure of a vehicle in such a way that said flattened configuration at the far end of the nozzle can lie flush with, or further inside than, the outer surface of said vehicle, close to the window, when the hollow inner rod is in a retracted position, and the nozzle and part of the hollow inner rod scan protrude from said outer surface when the hollow inner rod is in an extended position.

2. The device according to claim 1, wherein said assembly configuration comprises a lug which is joined laterally to the hollow outer sections.

3. The device according to claim 2, wherein said lug is oriented in the longitudinal direction of the hollow outer section and has an orifice for inserting a fixing element in a lateral direction with respect to the hollow outer sections.

4. The device according to claim 1, wherein the nozzle has a housing for a steerable element which includes a liquid outlet in a lateral position and a passage which communicates the inside of the hollow inner rod with said liquid outlet in different positions of said steerable element, said flattened configuration being joined on the outside to said housing.

5. The device according to claim 4, wherein said flattened configuration extends to a perimeter which is larger than that of the housing.

6. The device according to claim 5, wherein the outer surface of the vehicle has an opening with a perimeter wherein said perimeter of the flattened configuration scan be substantially adjusted when the hollow inner rod is in a retracted position, and from which the nozzle and part of the hollow inner rod protrude when the hollow inner rod is in an extended position.

7. The device according to claim 5, wherein said perimeters of the flattened configuration and said opening are circular.
